(19) United States
(12) Patent Application Publication
(10) Pub. No.: US 2006/0094453 A1
(43) Pub. Date: May 4, 2006

(54) Apparatus and method for setting multimedia items using an MMS message in a mobile terminal

(75) Inventor: Eun-Hui Rhyu, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/250,221

(22) Filed: Oct. 14, 2005

(30) Foreign Application Priority Data
Oct. 29, 2004 (KR) 2004-87454

(51) Int. Cl. H04Q 7/20

(52) U.S. Cl. 455/466

(57) ABSTRACT

Provided is an apparatus and method for setting multimedia using a Multimedia Messaging Service (MMS) message in a mobile terminal. The apparatus includes an encoder for encoding data for a multimedia setup item into an MMS message; and a controller for providing the multimedia setup item, controlling the encoder to encode the data for the multimedia setup item into the MMS message if multimedia transmission is selected, and transmitting the MMS message to a recipient selected by a user.

### PRIORITY

This application claims priority under 35 U.S.C. § 119 to an application entitled “Apparatus and Method for Setting Multimedia Using MMS Message in Mobile Terminal” filed in the Korean Intellectual Property Office on Oct. 29, 2004 and assigned Serial No. 2004-87454, the contents of which are incorporated herein by reference.

### BACKGROUND OF THE INVENTION

1. Field of the Invention

The present invention relates to an apparatus and method for setting multimedia items using a Multimedia Messaging Service (MMS) message in a mobile terminal.

2. Description of the Related Art

Recently, because of innovative development of network technology, mobile terminal subscribers have the ability to transmit and receive mobile messages to and from each other using mobile terminals. The mobile messages include Short Message Service (SMS) messages, Multimedia Messaging Service (MMS) messages, and e-mails. SMS, which allows the mobile terminal subscribers to transmit and receive short messages to and from each other, and wireless Internet access are becoming more and more popular.

In the SMS, if a mobile terminal subscriber transmits a short message to another mobile terminal subscriber in Korean or English, the other mobile terminal subscriber can receive the short message through a data communication network that may include the Public Switched Telephone Network (PSTN) and/or the Internet.

SMS is usually provided in one of two ways. The first exchanges a short message between a personal computer (PC) and a mobile terminal via the Internet. The second is an exchange between mobile terminals.

A specific mobile terminal is necessary to use the SMS, and a short message can be received while a subscriber talks on the mobile terminal. If a mobile terminal subscriber cannot receive a short message because the mobile terminal is off, the short message is stored to be read when the mobile terminal is turned on. In addition, the SMS enables information services providing stock information, weather forecasts, bank transactions such as account transfer, and e-commerce.

However, since the size of SMS data is small, it is difficult to apply SMS to moving pictures, except for a character message.

To overcome the problem, advanced digital mobile communication systems use a Multimedia Messaging Service System (MMSS) that supports SMS as well as basic voice service.

The MMSS is an upgraded form of the SMS and is a system in which multimedia data, such as music, still images, and video, can be transmitted and received in real time by adding visual elements to a limited text and voice message service.

As Multimedia Messaging Service Center (MMSC) client functions are added to mobile terminals with cameras, MMSC traffic is dramatically increasing, and it is predicted that in the future, MMS will be the most popular service of mobile communications, surpassing SMS.

An MMS message provided by the SSMS includes a media field and a presentation field. The media field includes multimedia clip data such as images, audio, and video. The presentation field includes temporal and spatial information on execution of the multimedia clip data. That is, the presentation field includes information on the time and a position to be displayed on a screen.

Therefore, comics, economic magazines, sports, and weather conditions can be provided more visually using the MMS message.

The process for registering items for setting multimedia, such as wall-paper, sub LCD (external display of dual LCD mobile phone), letters on an initial picture, an image shown when a message or a phone call is received from a predetermined person, a melody that rings when the phone call is received from a predetermined person, and a melody that rings when the message is received from a predetermined person in a mobile terminal, will now be described.

The mobile terminal should store individual multimedia content. The multimedia content can be stored in the mobile terminal by downloading, recording voice, and taking pictures using a built-in camera.

If a mobile terminal subscriber selects an “individual multimedia” item in a multimedia content management menu or a multimedia setup menu of the mobile terminal, items for setting multimedia, like those described above, are individually set. The process of registering the items for setting multimedia is troublesome and time-consuming because the multimedia items must be set individually.

### SUMMARY OF THE INVENTION

An object of the present invention is to substantially solve at least the above problems and/or disadvantages and to provide at least the advantages below. Accordingly, an object of the present invention is to provide an apparatus and method for setting multimedia items, such as wall-paper, sub LCD, letters on an initial picture, an image shown when a message or a phone call is received from a predetermined person, a melody that rings when the phone call is received from a predetermined person, and a melody that rings when the message is received from a predetermined person, using a Multimedia Messaging Service (MMS) message in a mobile terminal.

Another object of the present invention is to provide an apparatus and method for eliminating the troubles associated with individually setting multimedia items, such as wall-paper, sub LCD, letters on an initial picture, an image shown when a message or a phone call is received from a predetermined person, a melody that rings when the phone call is received from a predetermined person, and a melody that rings when the message is received from a predetermined person, in a mobile terminal.

According to one aspect of the present invention, there is provided an apparatus for setting multimedia items using a Multimedia Messaging Service (MMS) message in a mobile terminal. The apparatus includes an encoder for encoding data for a multimedia setup item into an MMS message; and a controller for providing the multimedia setup item, controlling the encoder to encode the data for the multimedia setup item into the MMS message if multimedia transmission is selected, and transmitting the MMS message to a recipient selected by a user.

According to another aspect of the present invention; there is provided a method of setting multimedia items using a Multimedia Messaging Service (MMS) message in a mobile terminal. The method includes providing a multimedia setup item; if the multimedia setup item is selected, encoding data for the multimedia setup item into the MMS message; and transmitting the MMS message to a recipient selected by a user.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile terminal according to a preferred embodiment of the present invention;

FIG. 2 is a flowchart illustrating a process of transmitting items for setting multimedia using an MMS message in the mobile terminal according to a preferred embodiment of the present invention;

FIGS. 3A through 3E are examples of menus shown on a mobile terminal screen when items for setting multimedia are transmitted using the MMS message in the mobile terminal;

FIG. 4 is a diagram illustrating a structure of the MMS message according to a preferred embodiment of the present invention;

FIG. 5 is a flowchart illustrating a process of receiving items for setting multimedia using an MMS message in a mobile terminal according to a preferred embodiment of the present invention; and

FIGS. 6A and 6B are examples of menus when multimedia setup is performed using the MMS message in the mobile terminal.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

The present invention is designed to transmit items for setting multimedia using a Multimedia Messaging Service (MMS) message in a transmission mobile terminal and to receive the MMS message and collectively set a multimedia setup item in a reception mobile terminal. Herein, the multimedia setup item may include wall-paper, sub LCD, letters on an initial picture, an image shown when a message or a phone call is received from a predetermined person, and a melody that rings when the phone call or message is received from a predetermined person.

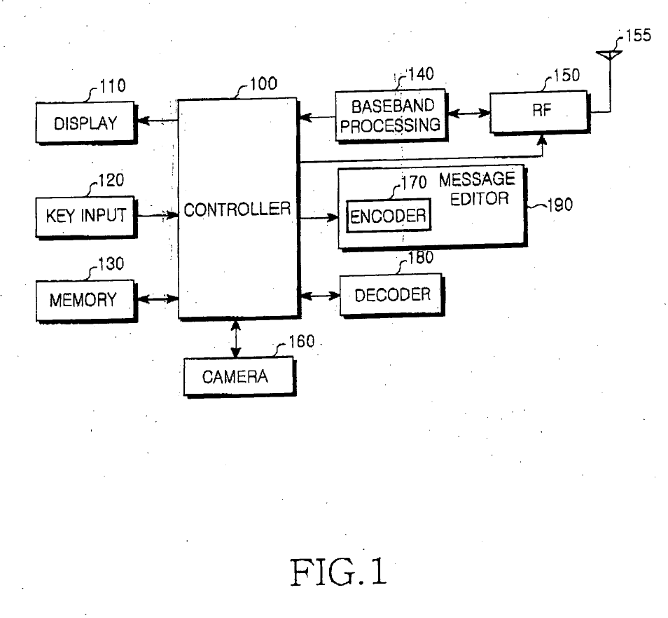

A block diagram of a mobile terminal according to a preferred embodiment of the present invention will now be described with reference to FIG. 1. Referring to FIG. 1, a controller 100 controls the operation of the mobile terminal.

The controller 100 edits data of a multimedia setup item, and encodes the edited data into an MMS message. The controller 100 transmits the MMS message to a recipient input by a user. The recipient may be a telephone number of another mobile terminal or an e-mail address.

When an MMS message is received, the controller 100 accesses an MMS server (not shown) to receive the MMS message. The controller 100 determines whether the received MMS message is related to the multimedia setup item based on a contents type field in a header of the MMS message. If the received MMS message is related to the multimedia setup item, the controller 100 decodes the MMS message and stores the decoded MMS message in a memory 130.

At the direction of the controller 100, a display unit 110 displays data corresponding to key-input data input from a key-input unit 120 and displays operational status and various kinds of information on the mobile terminal using icons, characters, and images. The display unit 110 visibly shows the operational status based on a function set or driven by the user. The display unit 110 displays a multimedia setup menu, a transmission menu used to transmit the MMS message, a reception menu used to receive the MMS message, and a setup menu used to set up each multimedia item from the received MMS message.

A key-input unit 120 has a plurality of keys, including number keys, for the user to enter key-input data to the controller 100. That is, the key-input unit 120 outputs key-input data corresponding to inputs of selected keys to the controller 100, and the controller 100 analyzes the key-input data to perform a corresponding operation according to the analyzed result.

The memory 130 includes Read Only Memory (ROM), Random Access Memory (RAM), and a voice memory to store a plurality of programs and information to control operation of the mobile terminal.

A radio frequency (RF) unit 150 transmits and receives an RF signal to and from a base station via an antenna 155. For reception, the RF unit 150 converts a received RF signal to an intermediate frequency (IF) signal and outputs the converted IF signal to a baseband processing unit 140. For transmission, the RF unit 150 converts an IF signal input from the baseband processing unit 140 to an RF signal and transmits the converted RF signal to the base station.

In this example, the baseband processing unit 140 is preferably a baseband analog ASIC (BAA) for interfacing between the controller 100 and the RF unit 150. The unit 140 converts a baseband digital signal input from the controller 100 to an analog IF signal and outputs the converted analog IF signal to the RF unit 150; it also converts an analog IF signal input from the RF unit 150 to a baseband digital signal and outputs the converted baseband digital signal to the controller 100. In use, the baseband processing unit 140 transmits the MMS message for setting the multimedia to the other party, and transmits received MMS messages for setting the multimedia items to the controller 100.

A camera 160 is installed in the mobile terminal as well. If a picture-taking-function key (not shown) is activated, or pressed, by the user, the key-input unit 120 transmits the key-input data to the controller 100. In response, the controller 100 controls the camera phone function of the mobile terminal. In the present embodiment, the wall-paper of the multimedia setup item may be a photo file obtained using the camera 160.

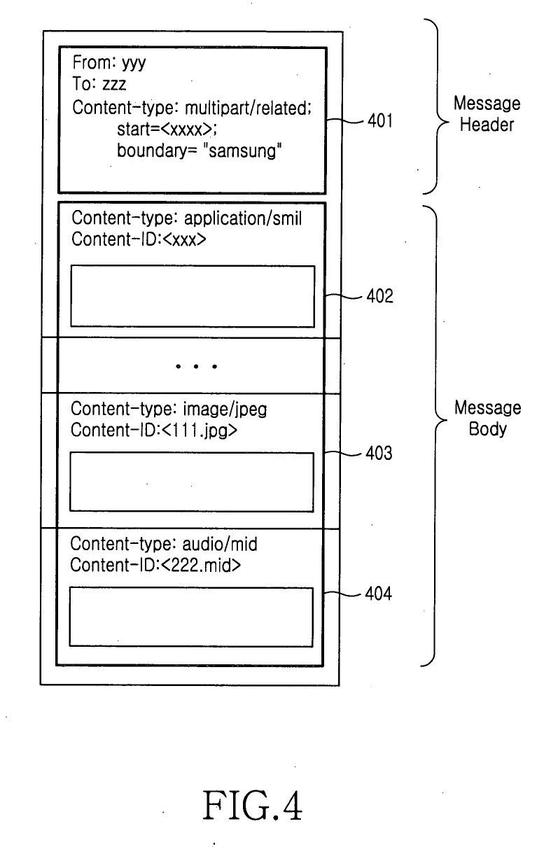

A message editor 190 edits a message for setting the multimedia items at the direction of the controller 100. The message includes a header 401, a setup command field 402, and a media field 403 as shown in FIG. 4. The header 401 includes information on a recipient and a caller, the media field 403 includes multimedia information such as audio and video, and the setup command field 402 includes information shown in Table 1, discussed below.

An encoder 170 encodes the message for setting the multimedia edited by the message editor 190 into an MMS message at the direction of the controller 100. If an MMS message of a multimedia setup item is received, a decoder 180 decodes data of the received multimedia setup item. The process of transmitting the MMS message of the multimedia setup item will now be described.

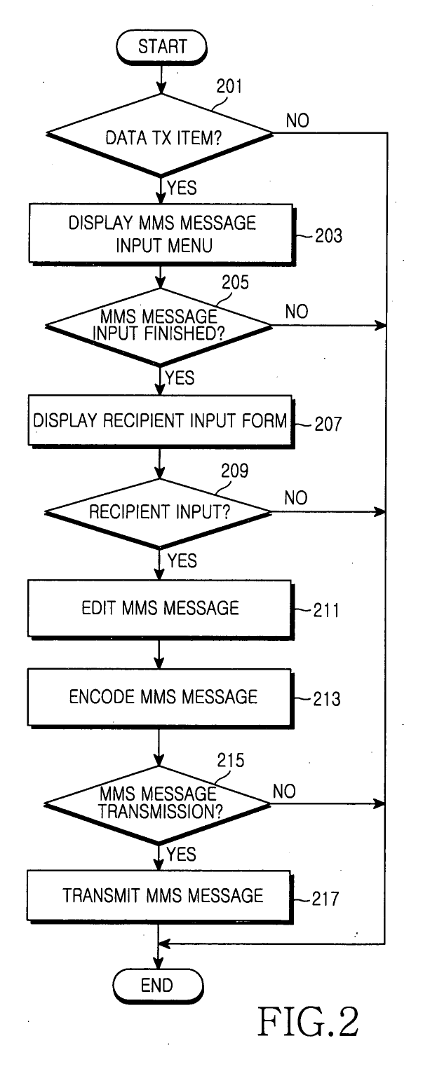

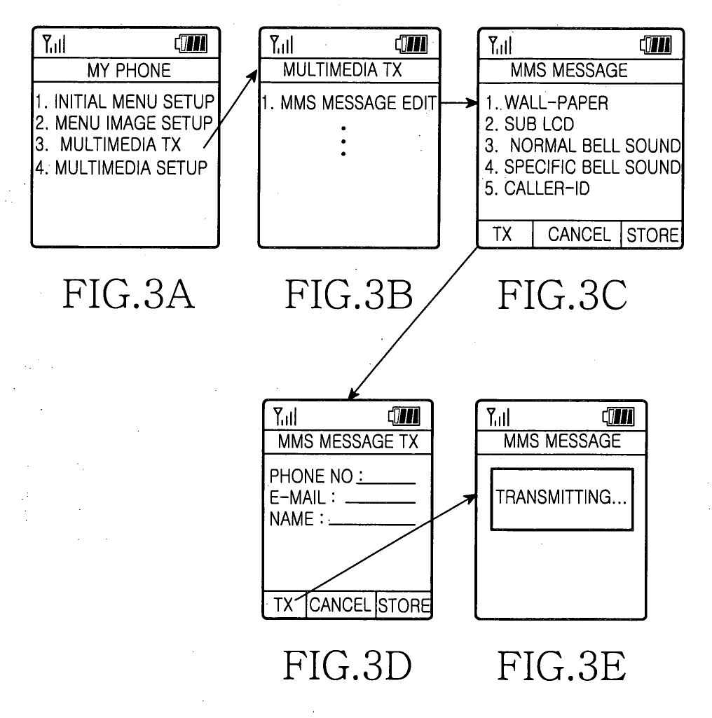

FIG. 2 is a flowchart illustrating the process of transmitting items for setting multimedia items using an MMS message in the mobile terminal according to a preferred embodiment of the present invention. FIGS. 3A through 3E are examples of menus shown on a mobile terminal screen when the items for setting the multimedia items are transmitted using the MMS message in the mobile terminal.

Referring to FIG. 2, the controller determines whether a data transmission item for setting the multimedia items is selected by the user in step 201. That is, if the user selects the item of “multimedia transmission” on the mobile terminal screen as shown in FIG. 3A, the controller 100 displays an MMS message input menu in step 203. The user selects an item of “MMS message edit” from a multimedia transmission menu as shown in FIG. 3B and inputs the MMS message as shown in FIG. 3C. Here, when inputting the MMS message, the user can input either all of the items for setting the multimedia such as wall-paper, sub LCD, letters on an initial picture, an image shown when a message or a phone call is received from a predetermined person, a melody that rings when a phone call or message is received from a predetermined person, or at least one selected item for setting multimedia as the MMS message.

The controller 100 determines whether inputting of the MMS message is finished in step 205. If the inputting of the MMS message is finished, the controller 100 displays a recipient input form shown in FIG. 3D in step 207. The controller 100 determines whether a recipient is input in step 209. If the recipient is input, the controller 100 edits the MSS message input by the user in step 211.

A conventional MSS message includes a header, a presentation field, and a media field. However, in the present embodiment, the MSS message includes the header 401, the setup command field 402, and the media fields 403 and 404 as shown in FIG. 4. The setup command field 402 includes items for setting multimedia such as wall-paper, sub LCD, letters on an initial picture, an image shown when a message or a phone call is received from a predetermined person, and a melody that rings when a phone call or message is received from a predetermined person. The media fields 403 and 404 include multimedia information such as images and audio. An MSS message editing method will now be described.

In step 211, as shown in FIG. 4, the controller 100 edits the message header 401 using the recipient and the caller. Thereafter, the controller 100 edits the setup command field 402, and the media fields 403 and 404 of the MSS message. The setup command field 402 can be edited as shown in Table 1.

TABLE 1

| Name | Value | Meaning |
|---|---|---|
| Configuration | Wall-paper | Background image setup item |
| item | Sub LCD-image | Outer screen image setup item |
| | Caller-id | Item for setting an image shown |
| | | when a message or a phone call is |
| | | received from a predetermined |
| | | person |
| | Caller-melody | Item for setting the image shown |
| | | when the message or the phone call |
| | | is received from a predetermined |
| | | person |
| | Msg-alert | Item for setting a melody rung |
| | | when the message is received from |
| | | a predetermined person |
| | Greeting-msg | Item for registering letters of |
| | | an initial picture |
| Caller-number | | Telephone number |
| Caller-email | | E-mail address string |
| Caller-firstname | Character string | Character string |
| Caller-lastname | Character string | Character string |

In the setup command field 402 of the MSS message, the items for setting multimedia shown in Table 1 are edited using a synchronized multimedia integration language (SMIL). The items for setting multimedia shown in Table 1 include: the “Wall-paper” indicating the background image setup item; the “Sub LCD” indicating the outer screen image setup item; the “Caller-id” indicating the item for setting an image shown when a message or a phone call is received from a predetermined person; the “Caller-melody” indicating the item for setting the image shown when the message or the phone call is received from a predetermined person; the “Msg-alert” indicating the item for setting a melody rung when the message is received from a predetermined person; and, the “Greeting-msg” indicating the item for registering letters of an initial picture.

Besides the items for setting the multimedia, the setup command field 402 further includes the “Caller-number” including the telephone number, the “Caller-email” indicating the e-mail address string, the “Caller-firstname” and the “Caller-lastname” indicating the character string.

The controller 100 encodes the edited message into an MSS message in step 213. In step 215, the controller 100 determines whether an MSS message transmission button is activated. If the user activates the transmission button shown in FIG. 3D, the controller 100 transmits the MSS message to a recipient mobile terminal in step 217. The transmission state of the MSS message is displayed as shown in FIG. 3E. The process of receiving items for setting multimedia using an MMS message in the mobile terminal will now be described.

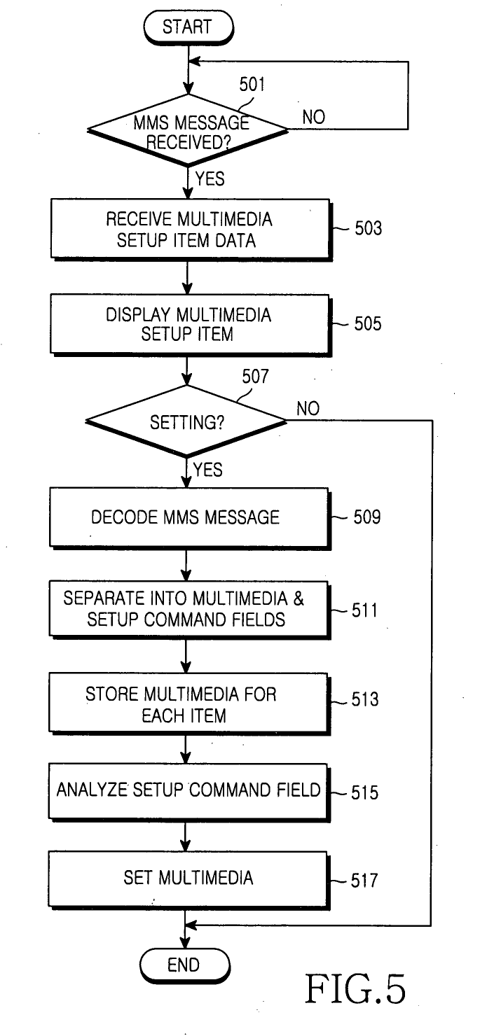

FIG. 5 is a flowchart illustrating a process of receiving the items for setting multimedia using an MMS message in the mobile terminal according to a preferred embodiment of the present invention.

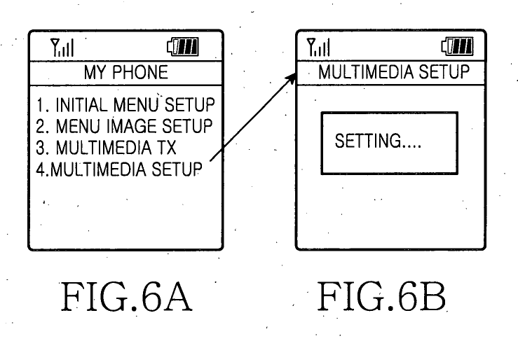

Referring to FIG. 5, the controller 100 determines whether an MMS message including data of a multimedia setup item is received in step 501. If it is received, the controller 100 accesses the MMS server and receives the multimedia setup item data in step 503. The controller 100 displays an item of “MULTIMEDIA SETUP” through the display unit 110 in step 505. That is, if “MULTIMEDIA SETUP” is selected as shown in FIG. 6A, the controller 100 determines whether the multimedia setup item is selected in step 507.

If “MULTIMEDIA SETUP” is selected, the controller 100 decodes the MMS message in step 509. The controller 100 separates the decoded MMS message into the media fields 403 and 404 including information, such as images and audio, and the setup command field 402 in step 511. The controller 100 checks the MMS message and stores the multimedia for each item included in the media fields 403 and 404 in memory 130 in step 513. The controller 100 analyzes the setup command field 402 in step 515. In step 517, the controller 100 sets multimedia items according to information on the items for setting the multimedia shown in Table 1 by analyzing the setup command field 402.

As described above, in the inventive apparatus and method, the troubles associated with individually setting multimedia items are removed by setting a multimedia setup item including wall-paper, sub LCD, a normal bell sound, a specific bell sound, and a caller-id using an MMS message.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for transmitting items for setting multimedia in a mobile terminal, comprising:
an encoder for encoding data for a multimedia setup item into a Multimedia Messaging Service (MMS) message; and
a controller for providing the multimedia setup item, controlling the encoder to encode the data for the multimedia setup item into the MMS message if multimedia transmission is selected, and transmitting the MMS message to a recipient selected by a user.

2. The apparatus of claim 1, wherein the MMS message comprises
a header including a caller and a recipient,
a setup command field, and
a media field including multimedia information,
wherein the setup command field includes a background image setup item, an outer screen image setup item, an item for setting an image shown when a message or a phone call is received from a predetermined person, an item for setting the melody rung when the message or the phone call is received from the predetermined person, and an item for registering letters of an initial picture.

3. The apparatus of claim 1, further comprising a decoder for decoding the MMS message, wherein when the MMS message including data of a multimedia setup item is received, the controller controls the decoder to decode the MMS message and sets the multimedia setup item in the mobile terminal using the MMS message.

4. An apparatus for receiving items for setting multimedia in a mobile terminal, comprising:
a decoder for receiving a Multimedia Messaging Service (MMS) message from a caller mobile terminal and decoding the received MMS message; and
a controller for, upon receiving the MMS message including data of a multimedia setup item, controlling the decoder to decode the MMS message and setting the multimedia setup item in the mobile terminal using the MMS message.

5. The apparatus of claim 4, wherein the MMS message comprises
a header including a caller and a recipient,
a setup command field, and
a media field including multimedia information,
wherein the setup command field includes a background image setup item, an outer screen image setup item, an item for setting an image shown when a message or a phone call is received from a predetermined person, an item for setting a melody rung when the phone call or message is received from the predetermined person, and an item for registering letters of an initial picture.

6. A method of transmitting items for setting multimedia in a mobile terminal, comprising:
providing a multimedia setup item;
if the multimedia setup item is selected, encoding data for the multimedia setup item into a Multimedia Messaging Service (MMS) message; and
transmitting the MMS message to a recipient selected by a user.

7. The method of claim 6, wherein the MMS message comprises
a header including a caller and a recipient,
a setup command field, and
a media field including multimedia information,
wherein the setup command field includes a background image setup item, an outer screen image setup item, an item for setting an image shown when a message or a phone call is received from a predetermined person, an item for setting a melody rung when the message or phone call is received from the predetermined person, and an item for registering letters of an initial picture.

8. A method of receiving and setting items for setting multimedia in a mobile terminal, comprising:
upon receiving a Multimedia Messaging Service (MMS) message from a caller mobile terminal, checking fields of the MMS message and determining whether the MMS message is a message including data of a multimedia setup item;
if the MMS message received from the caller mobile terminal is the message including the data of the multimedia setup item, decoding the MMS message; and
setting the multimedia according to the items for setting the multimedia included in the MMS message.

9. The method of claim 8, wherein the MMS message comprises
a header including a caller and a recipient,
a setup command field, and
a media field including multimedia information,
wherein the setup command field includes a background image setup item, an outer screen image setup item, an item for setting an image shown when a message or a phone call is received from a predetermined person, an item for setting a melody rung when the message or phone call is received from the predetermined person, and an item for registering letters of an initial picture.
